(19) United States
(12) Patent Application Publication
(10) Pub. No.: US 2017/0355256 A1
(43) Pub. Date: Dec. 14, 2017

(54) ENGINE MOUNT, SYSTEM AND METHOD

(71) Applicant: Vibracoustic North America L.P., South Haven, MI (US)

(72) Inventors: Patrick Lamm, Kalamazoo, MI (US); Benjamin Hughes, St. Joseph, MI (US)

(21) Appl. No.: 15/621,360

(22) Filed: Jun. 13, 2017

Related U.S. Application Data
(60) Provisional application No. 62/349,878, filed on Jun. 14, 2016.

(51) Int. Cl. B60K 5/12; F02F 7/00

(52) U.S. Cl. CPC B60K 5/1208; F02F 7/0082

(57) ABSTRACT

An engine mount includes a center pin, a main rubber element, and a housing. In embodiments, the main rubber element may include at least one joining plate with at least one tab, and may be configured to at least partially encapsulate the center pin and the at least one joining plate. The housing may be configured to receive and/or engage the main rubber element including the center pin and the at least one joining plate. The main rubber element may be secured to the housing via the at least one joining plate and/or the at least one tab.

### CROSS-REFERENCE TO RELATED APPLICATIONS

This application claims the benefit of U.S. provisional application No. 62/349,878, filed 14 Jun. 2016, which is hereby incorporated by reference as though fully set forth herein.

### BACKGROUND

### a. Technical Field

The present disclosure relates to engine mounts, and methods and systems relating to engine mounts, including geometrically-shaped engine mounts.

### b. Background Art

This background description is set forth below for the purpose of providing context only. Therefore, any aspects of this background description, to the extent that it does not otherwise qualify as prior art, is neither expressly nor impliedly admitted as prior art against the instant disclosure.

An engine mount may be used to connect (e.g., secure) an engine to a portion (e.g., frame, body) of a vehicle. In addition to connecting an engine to a vehicle, an engine mount may have other purposes, such as, but not limited to, dampening vibration. An engine mount may include a dampening component, to reduce (e.g., absorb) vibrations from the engine and/or to prevent vibrations from being transmitted (e.g., conducted) through the engine mount to the vehicle. An engine mount may also reduce movement (e.g., shaking, displacement) of the engine due to acceleration, braking, rough terrain, and/or other operations of the engine. Some of these movements may be more severe in one direction than in another direction. For example, movement in the up/down direction (i.e., relative to gravity) may be more severe than in the fore/aft direction. An engine mount may also contribute to supporting the weight of the engine and/or its related components. The forces (e.g., vibrations, engine movement, weight of the engine) that may be applied to an engine mount may cause it to be less durable and/or less effective in reducing vibrations and/or engine movements.

The foregoing discussion is intended only to illustrate the present field and should not be taken as a disavowal of claim scope.

### SUMMARY

In an embodiment, a geometrically-shaped (e.g., V-shaped, X-shaped, and/or polygonal) engine mount may include a center pin, a main rubber element, a joining plate, a tab, a housing, an attachment point, a tab slot, a frame mount, and/or a recess. The center pin may be configured to be at least partially encapsulated by (e.g., over-molded by and/or adhered to) the main rubber element. The center pin may be constructed of metal (e.g., ductile cast iron) and/or may include one or more attachment points (e.g., holes, bolts, studs, nuts) that may be configured to receive a component (e.g., an engine). The center pin may be configured to engage and/or adhere to one or more surfaces of the main rubber element. The main rubber element may be constructed of a pliable material (e.g., rubber, polymer). At least one joining plate may be configured at least partially within the main rubber element. The joining plate may include a tab that may be manipulated (e.g., bent) to engage the center pin and/or a housing. The housing may be configured with a tab slot and/or a recess to receive the tab that may be connected to the main rubber element, the joining plate, and/or the center pin.

In an embodiment, an engine mount assembly may include a center pin, at least one joining plate, a main rubber element, that may be formed about at least a portion of the center pin and the at least one joining plate. A housing may be configured to receive at least a portion at least one of: the main rubber element, the center pin, and the at least one joining plate.

In an embodiment, an engine mount assembly may include a center pin that may include at least one attachment point, wherein the attachment point may be configured to receive at least one fastener.

In an embodiment, an engine mount assembly may include at least one joining plate includes at least one tab, wherein at least a portion of the at least one tab may be deflected to engage at least a portion of the housing.

In an embodiment, an engine mount assembly may include a housing that may include at least one attachment point, wherein the attachment point may be configured to receive at least one fastener.

In an embodiment, an engine mount assembly may include at least one joining plate and may include at least one passage to engage a portion of the main rubber element.

In an embodiment, an engine mount assembly may include a center pin that may be at least partially coated by at least one of: a phosphate coating; a primer; and an adhesive.

In an embodiment, an engine mount assembly may include at least one joining plate that may be at least partially coated by at least one of: a phosphate coating; a primer; and an adhesive.

In an embodiment, an engine mount assembly may include a housing that may be at least partially e-coated.

In an embodiment, an engine mount assembly may include a center pin that may be separated from the at least one joining plate by a portion of the main rubber element.

In an embodiment, an engine mount assembly may include at least a portion of the at least one joining plate, encapsulated by the main rubber element, and may engage at least a portion of the housing.

In an embodiment, an engine mount assembly may include a first joining plate that may be oriented at a first angle relative to an axis of the center pin, and a second joining plate that may be oriented at a second angle relative to the axis of the center pin.

In an embodiment, an engine mount assembly may include a first joining plate that may be oriented at a first angle relative to an axis of the center pin, and a second joining plate that may be oriented at a second angle relative to the axis of the center pin.

In an embodiment, an engine mount assembly may include a center pin, a first and a second joining plate, a main rubber element, that may be formed about at least a portion of the center pin and the first and the second joining plate, and a housing that may be configured to receive at least a portion of the main rubber element, the center pin, and the first and the second joining plate.

In an embodiment, an engine mount assembly may include a first and the second joining plate and may include at least one tab that may be configured to engage the housing.

In an embodiment an engine mount assembly may include a main rubber element that may be formed about at least a portion of the center pin and the first and the second joining plate such that the main rubber element may be disposed between the center pin and the first and the second joining plate.

In an embodiment an engine mount assembly may include at least a portion of the first joining plate and the second joining plate that may be encapsulated by the main rubber element and may engage at least a portion of the housing.

In an embodiment, a method for producing an engine mount assembly may include placing at least one joining plate and a center pin at least partially into a mold, injecting the mold with a material that at least partially encapsulates the at least one joining plate and the center pin, forming a main rubber element, removing the main rubber element from the mold, the main rubber element including the at least one joining plate and the center pin and inserting the main rubber element into a housing, wherein at least one of the main rubber element, the at least one joining plate, and the center pin may engage the housing.

In an embodiment, a method for producing an engine mount assembly may include at least one joining plate and a center pin that may be separated from each other, allowing a material to flow between the at least one joining plate and the center pin.

In an embodiment, a method for producing an engine mount assembly may include coating at least a portion of at least one joining plate, the center pin, and the housing with at least one of: a phosphate coating, a primer, and an adhesive.

The foregoing and other aspects, features, details, utilities, and advantages of the present disclosure will be apparent from reading the following description and claims, and from reviewing the accompanying drawings.

### BRIEF DESCRIPTION OF THE DRAWINGS

FIG. 1 is an exploded view generally illustrating an embodiment of an engine mount in accordance with teachings of the present disclosure.

FIG. 2 is a sectional view generally illustrating an embodiment of an engine mount in accordance with teachings of the present disclosure.

FIGS. 3A-3B are front perspective views generally illustrating embodiments of an engine mount in accordance with teachings of the present disclosure.

FIG. 4 is a rear perspective view generally illustrating an embodiment of an engine mount in accordance with teachings of the present disclosure.

FIG. 5 is a perspective view generally illustrating an embodiment of an engine mount assembly/system in accordance with teachings of the present disclosure.

### DETAILED DESCRIPTION

Before proceeding to a detailed description of an engine mount, system and method, an overview description of such an apparatus will first be described. This document will also describe various embodiments for implementing the apparatus, as well as variations.

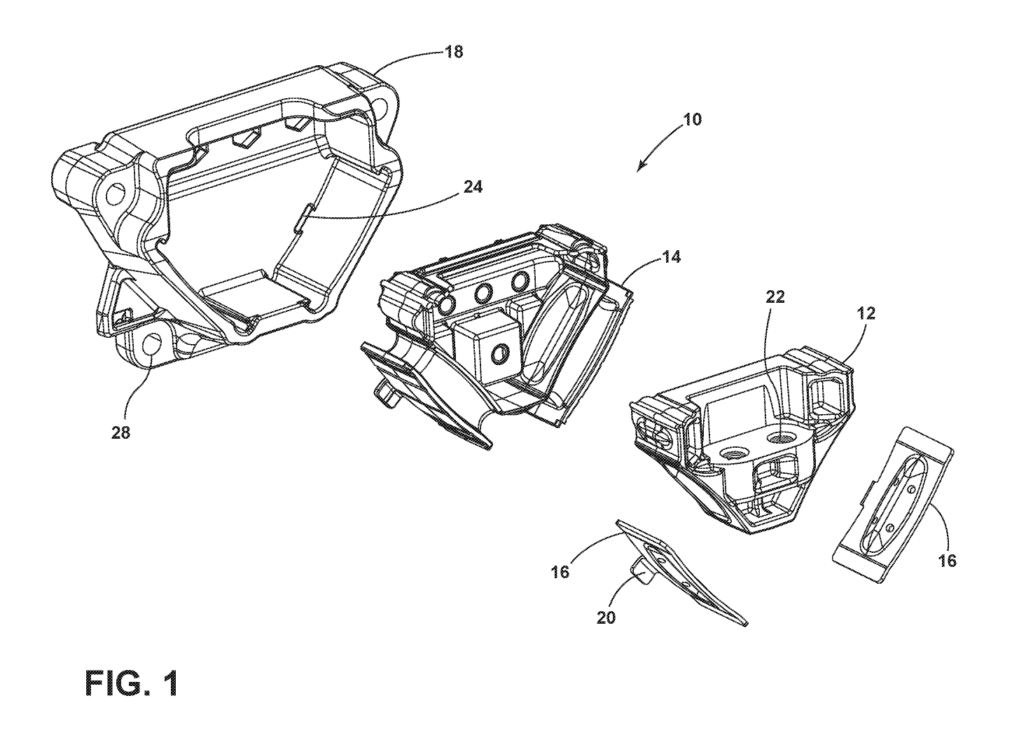

Referring now to the drawings wherein like reference numerals are used to identify identical or similar components in the various views, FIG. 1 is a diagrammatic view of an apparatus 10. As described in the Background, an embodiment of an engine mount 10, may be characterized, or referred to, as a geometrically-shaped (e.g., V-shaped, X-shaped, and/or polygonal), engine mount. Embodiments of an engine mount may include a center pin 12, a main rubber element 14, a joining plate 16, a housing 18, a tab 20, an attachment point 22, a tab slot 24, and/or a frame mount 28. Center pin 12 may be comprised of metal (e.g., ductile cast iron), and/or other suitable material (e.g., composite and/or polymer). Center pin 12 may include an attachment point 22. Center pin 12 may be configured to engage and/or adhere to one or more surfaces of main rubber element 14. Center pin 12 may be configured (e.g., machined), to receive a fastener (e.g., bolt). Center pin 12 may include additional elements, such as an assembly locating device (e.g., post), identifying mark (e.g., manufacturer, date of manufacture, serial number, mold number, orientation). Center pin 12 may include a strengthening formation or element (e.g., gusset(s), webbing, bracing) that may alter (e.g., improve), the characteristics of center pin 12.

A center pin 12 of an engine mount 10 may be at least partially adhered to and/or over-molded (e.g., encapsulated), by a main rubber element 14. In an embodiment, a center pin 12 may be placed into a forming device (e.g., injection mold), and a material (e.g., rubber, polymer), may be formed (e.g., injected), around at least a portion of center pin 12 to encapsulate (e.g., adhere to and/or join), at least a portion of center pin 12 with main rubber element 14. Main rubber element 14 may, through a formation/molding process, conform to at least a portion of center pin 12. For example, main rubber element 14 may adhere and/or engage (e.g., contact or grip), a surface of center pin 12 such that little or no space may be present between center pin 12 and/or main rubber element 14. In an embodiment, center pin 12 may be configured to be separable from main rubber element 14. Additionally or alternatively, a center pin 12 may be affixed (e.g., adhered), to main rubber element 14.

Additionally, a center pin 12 of an engine mount 10 may be configured (e.g., inserted or pressed), within a main rubber element 14. Center pin 12 may be provided (e.g., pressed, formed, or forced), into a main rubber element 14 using equipment (e.g., a press or die). Center pin 12, as constructed, may include physically treating (e.g., heating, stretching, deforming), center pin 12 and/or main rubber element 14. Center pin 12 may be configured so that engagement with main rubber element 14 may be resistive (e.g., a friction fit). Main rubber element 14 may adhere to (e.g., contact or grip), a surface of center pin 12. Center pin 12 may be protected by a corrosion inhibitor (e.g., phosphate), and/or at least portions of center pin 12 may be coated with a primer and/or an adhesive. After center pin 12 is over-molded into main rubber element 14, at least a portion of center pin 12 left exposed (i.e., not over-molded), may be coated with a corrosion protective paint.

A main rubber element 14 of an engine mount 10, may be geometrically-shaped (e.g., V-shaped, X-shaped, or polygonal). In an embodiment, an engine mount 10 may be comprised of a pliable material (e.g., rubber and/or polymer). Main rubber element 14 may be formed via a mold (e.g., an injection mold), that may include surfaces that generally correspond to other components of the engine mount 10, such as, but not limited to, the center pin 12 and/or the housing 18. In an embodiment, a main rubber element 14 may include an element or feature (e.g., varied cross-section or webbing), that can, among other things, serve to alter (e.g., strengthen and/or make more pliable), certain features or characteristics of the main rubber element 14. For example and without limitation, a portion of the main rubber element 14 may be configured to have a large cross-section comprised of a pliable material, such that the portion may, inter alia, serve as a cushion and/or shock absorber.

Additionally, the main rubber element 14 of the engine mount 10 may be constructed including over-molded (e.g., adhered and/or encapsulated), components, such as, but not limited to, a joining plate 16 with a tab 20. Joining plate 16 and/or tab 20 may be inserted into a mold for producing main rubber element 14. As the material (e.g., rubber, pliable compound), of main rubber element 14 material may be injected (e.g., flow), into the mold, joining plate 16 and/or tab 20 may be at least partially encapsulated by the material of main rubber element 14. Additionally, in an embodiment, main rubber element 14 may be integrated (e.g., adhered, or combined). It should be understood that at least a portion of joining plate 16 and/or tab 20, may be encapsulated by and/or adhered to the material of main rubber element 14. In embodiments, a portion of a joining plate 16 and/or tab 20 may remain at least partially uncovered (e.g., exposed), by the material of main rubber element 14.

A joining plate 16 with a tab 20 of the engine mount 10 may be comprised of metal (e.g., steel) or other suitable materials (e.g., composite or polymer). Joining plate 16 and/or tab 20 may be configured to be adhered to and/or encapsulated (e.g., over-molded), by a material of the main rubber element 14. Joining plate 16 and/or tab 20 may include an element that may improve the adhesion and/or encapsulation by the material of main rubber element 14, such as, but not limited to, a hole (e.g., aperture or opening), through which the material of main rubber element 14 may flow (e.g., be injected through). The element may improve the physical connection (e.g., adhesion and/or encapsulation), of joining plate 16 and/or tab 20 with the material of main rubber element 14. Joining plate and/or tab 20 may engage and/or adhere to other components, such as, but not limited to, the center pin 12 and/or the housing 18 of an engine mount 10.

Additionally, the joining plate 16 with the tab 20 of the engine mount 10 may be configured to be adhered to and/or encapsulated (e.g., over-molded), by the material of the main rubber element 14. Joining plate 16 and/or tab 20 may engage other components of the engine mount 10, such as, but not limited to, the center pin 12 and/or the housing 18. Joining plate 16 and/or tab 20 may, at least partially, be encapsulated by and/or adhered to main rubber element 14. The combined main rubber element 14, joining plate 16, and/or tab 20 may be inserted into, or otherwise connected to, housing 18. Main rubber element 14 may adhere to and/or engage a surface of joining plate 16, housing 18, and/or tab 20. Joining plate 16 and/or tab 20 may engage a tab slot 24 of housing 18. Tab 20 may be manipulated (e.g., bent), such that tab 20 may secure the combined center pin 12/main rubber element 14/joining plate 16, and/or tab 20 to housing 18, such as via tab slot 24 and/or recess 32. Joining plate 16 may be protected by a corrosion inhibitor (e.g., phosphate), and/or at least portions of center pin 12 may be coated with a primer and/or an adhesive. After joining plate 16 is over-molded into main rubber element 14, at least a portion of joining plate 16 left exposed (i.e., not over-molded), may be coated with a corrosion protective paint.

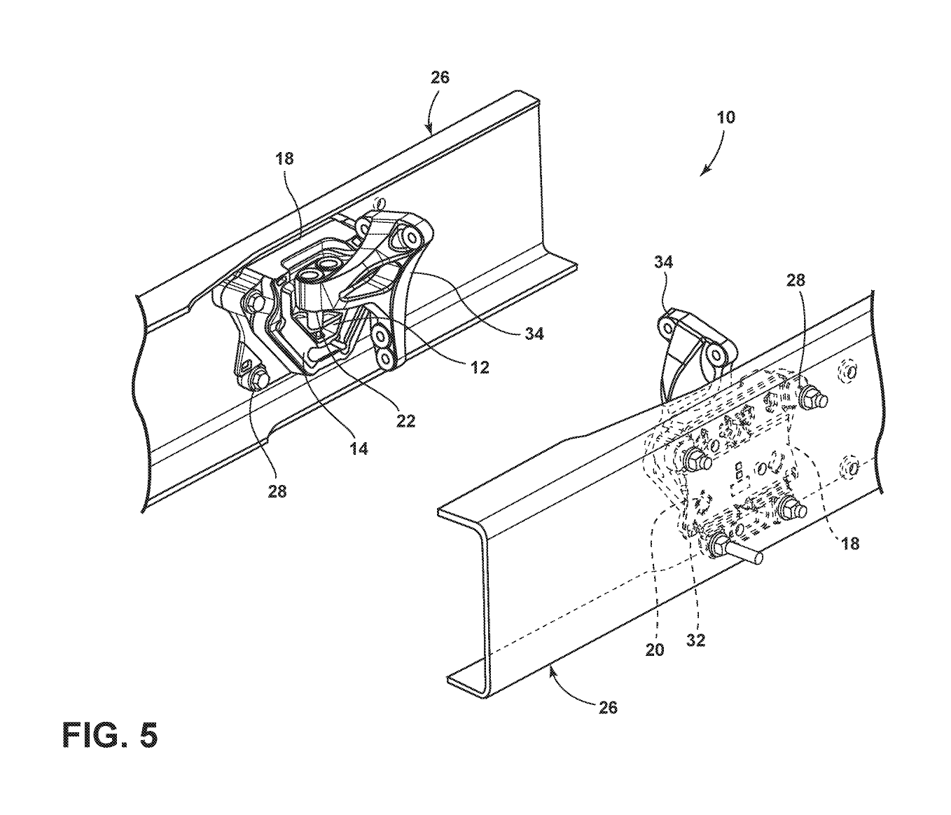

The housing 18 of the engine mount 10 may include a standoff 30 that may be configured to engage a vehicle frame 26 (as shown in FIG. 5). Standoff 30 may be configured in size, shape and/or form (e.g., T-shape, cylinder, block), to aid in or facilitate installation of an engine mount (e.g., a V-shaped, X-shaped, or polygonal engine mount), to a vehicle frame 26. For example, the standoff 30 may engage a portion of the vehicle frame 26 that may substantially correspond to at least a portion of the standoff 30. Housing 18 may include a recess 32 that may be configured to receive tab 20 via tab slot 24. Tab 20 may be bent (e.g., manipulated), such that at least a portion of tab 20 may engage recess 32 of housing 18 via tab slot 24. The engagement of tab 20 to recess 32 via tab slot 24 may secure center pin 12, main rubber element 14, and/or joining plate 16 to housing 18. Housing 18 may be at least partially e-coated (i.e., electrophoretic painting), to inhibit corrosion.

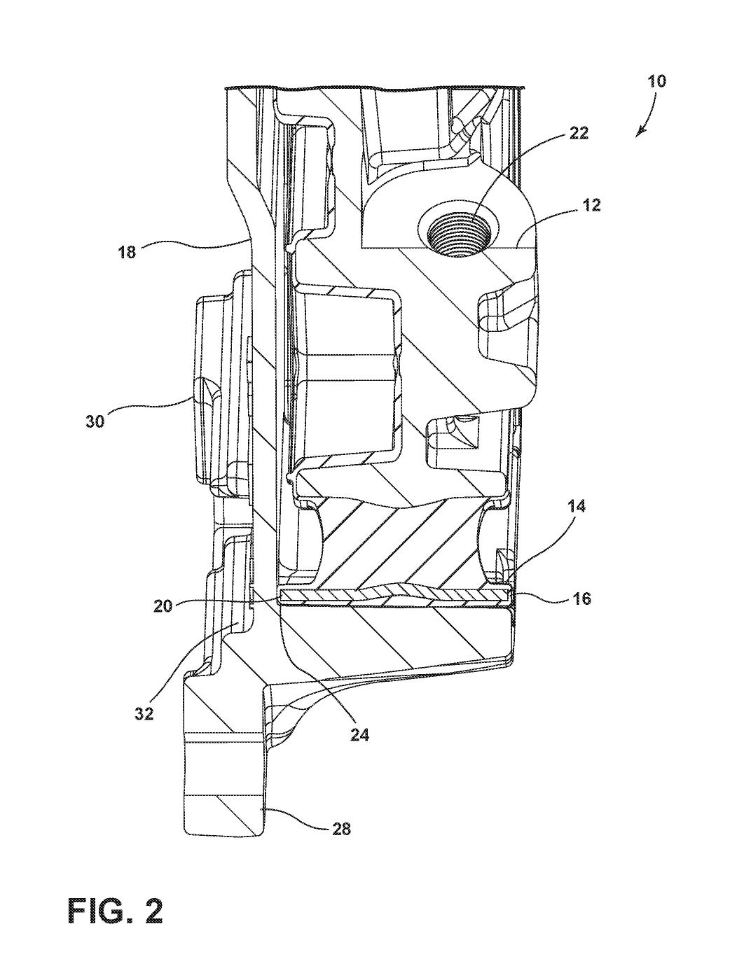

FIG. 2 generally illustrates an engine mount 10 that may include a center pin 12, a main rubber element 14, a joining plate 16, a housing 18, a tab 20, an attachment point 22, a tab slot 24, a frame mount 28, a standoff 30, and/or a recess 32. An attachment point 22 may be configured in a center pin 12 to receive a fastener (e.g., bolt, not shown), that may secure an engine to an engine mount 10. Center pin 12 may be at least partially adhered to and/or encapsulated by main rubber element 14. Joining plate 16 with tab 20 may be at least partially adhered to and/or encapsulated by main rubber element 14. Center pin 12, joining plate 16, and/or tab 20 may be received by at least a portion of housing 18. Tab 20 may extend beyond tab slot 24 of housing 18. Tab 20 may be bent (e.g., manipulated), such as about tab slot 24, that may engage recess 32. Tab 20 may, after manipulation into recess 32, secure center pin 12, main rubber element 14, and/or joining plate 16 to housing 18. Housing 18 may include frame mount 28 that may receive a fastener (e.g., bolt or stud), that may be connected to a vehicle. Standoff 30 may be configured on housing 18 such that standoff 30 that may engage the vehicle and that may affect the positioning of an engine mount 10 relative to the vehicle.

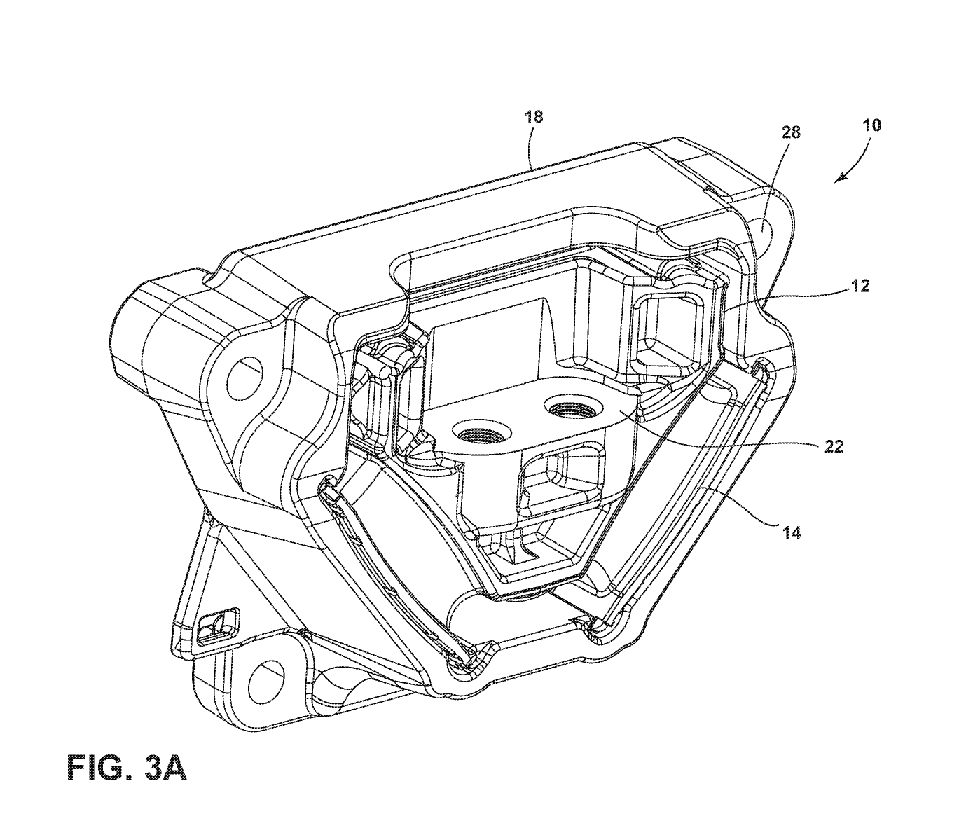

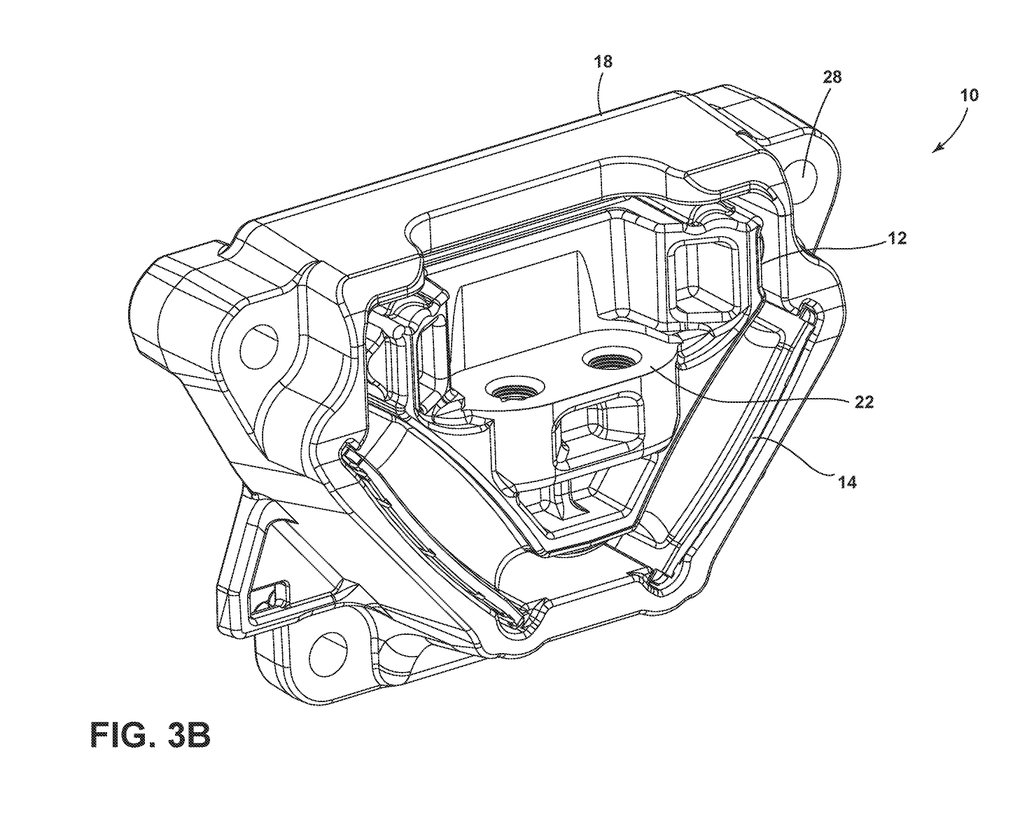

FIGS. 3A-3B generally illustrate the engine mount 10 (e.g., a V-shaped, X-shaped, or polygonal engine mount), that may include the center pin 12, the main rubber element 14, the joining plate 16, the housing 18, the tab 20, the attachment point 22, and/or the frame mount 28. Center pin 12 may be configured to be at least partially adhered to and/or encapsulated by main rubber element 14. Attachment point 22 may be configured to engage a portion of an engine via a fastener (e.g., bolt, pin, or stud). Joining plate 16 with tab 20 may be configured to be at least partially encapsulated by main rubber element 14. Housing 18 may be configured to receive main rubber element 14 containing joining plate 16 and/or tab 20. Housing 18 may include frame mount 28 that may permit an engine mount 10 to be secured to a portion of a vehicle, such as vehicle frame 26 (as shown in FIG. 5).

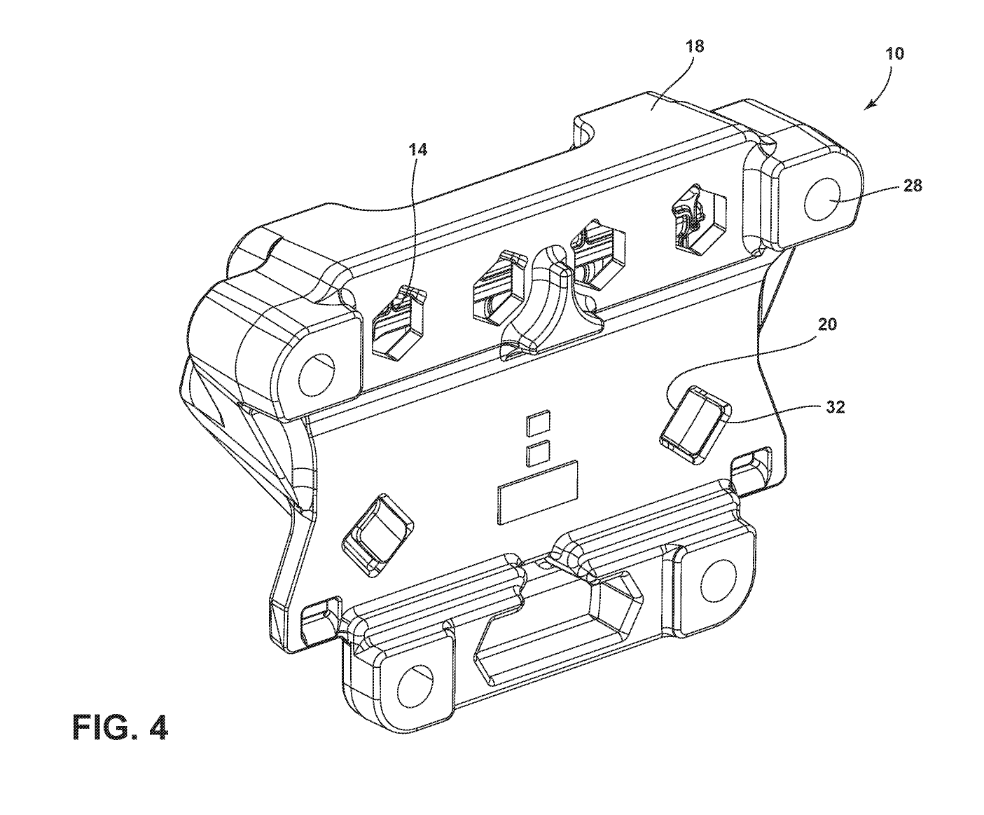

FIG. 4 generally illustrates the engine mount 10 that may include the center pin 12, the main rubber element 14, the joining plate 16, the housing 18, the tab 20, an attachment point 22, the tab slot 24, the frame mount 28, the standoff 30, and/or a recess 32. Main rubber element 14 may be configured to include joining plate 16 with tab 20. Main rubber element 14, joining plate 16, and/or tab 20 may be secured to housing 18 by inserting tab 20 of joining plate 16 through tab slot 24 and/or manipulating (e.g., bending), tab 20 into recess 32. Tab 20 and/or joining plate 16 may be encapsulated by main rubber element 14. Housing 18 may include standoff 30 that may be configured to align and/or stabilize housing 18 against a portion of a vehicle via frame mount 28 (as shown in FIG. 5).

FIG. 5 generally illustrates the engine mount 10 that may include the center pin 12, the main rubber element 14, the joining plate 16, the housing 18, the tab 20, the attachment point 22, the tab slot 24, the vehicle frame 26, the frame mount 28, the standoff 30, the recess 32, and/or the engine 34. Center pin 12 may be configured to receive engine 34 via attachment point 22. Center pin 12 may be at least partially adhered to and/or encapsulated by main rubber element 14. Joining plate 16 with tab 20 may be configured to be adhered to and/or encapsulated by main rubber element 14. Main rubber element 14, joining plate 16, and/or tab 20 may be secured to housing 18 via tab 20 of joining plate 16 passing through tab slot 24 and/or being bent into recess 32. Housing 18 may include standoff 30 that may be configured to align and/or stabilize housing 18 against a portion of a vehicle via frame mount 28.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

Although only certain embodiments have been described above with a certain degree of particularity, those skilled in the art could make numerous alterations to the disclosed embodiments without departing from the scope of this disclosure. All directional references (e.g., plus, minus, upper, lower, upward, downward, left, right, leftward, rightward, top, bottom, above, below, vertical, horizontal, clockwise, and counterclockwise), are only used for identification purposes to aid the reader's understanding of the present disclosure, and do not create limitations, particularly as to the position, orientation, or use of embodiments. Joinder references (e.g., attached, coupled, connected, and the like), are to be construed broadly and may include intermediate members between a connection of elements and relative movement between elements. As such, joinder references do not necessarily imply that two elements are directly connected/coupled and in fixed relation to each other. It is intended that all matter contained in the above description or shown in the accompanying drawings shall be interpreted as illustrative only and not limiting. Changes in detail or structure may be made without departing from the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While one or more particular embodiments have been shown and described, it will be understood by those of skill in the art that various changes and modifications can be made without departing from the spirit and scope of the present teachings.

What is claimed is:

1. An engine mount assembly, the assembly comprising:
a center pin;
at least one joining plate;
a main rubber element, formed about at least a portion of the center pin and the at least one joining plate; and
a housing configured to receive at least a portion at least one of: the main rubber element, the center pin, and the at least one joining plate.

2. The engine mount assembly of claim 1, wherein the center pin includes at least one attachment point, wherein the attachment point is configured to receive at least one fastener.

3. The engine mount assembly of claim 1, wherein the at least one joining plate includes at least one tab.

4. The engine mount assembly of claim 3, wherein at least a portion of the at least one tab is deflected to engage at least a portion of the housing.

5. The engine mount assembly of claim 1, wherein the housing includes at least one attachment point, wherein the attachment point is configured to receive at least one fastener.

6. The engine mount assembly of claim 1, wherein the at least one joining plate includes at least one passage to engage a portion of the main rubber element.

7. The engine mount assembly of claim 1, wherein the center pin is at least partially coated by at least one of:
a) a phosphate coating;
b) a primer; and
c) an adhesive.

8. The engine mount assembly of claim 1, wherein the at least one joining plate is at least partially coated by at least one of:
a) a phosphate coating;
b) a primer; and
c) an adhesive.

9. The engine mount assembly of claim 1, wherein the housing is at least partially e-coated.

10. The engine mount assembly of claim 1, wherein the center pin is separated from the at least one joining plate by a portion of the main rubber element.

11. The engine mount assembly of claim 1, wherein at least a portion of the at least one joining plate, encapsulated by the main rubber element, engages at least a portion of the housing.

12. The engine mount assembly of claim 1, wherein a first joining plate is oriented at a first angle relative to an axis of the center pin, and a second joining plate is oriented at a second angle relative to the axis of the center pin.

13. The engine mount assembly of claim 12, wherein the first angle is opposite of the second angle.

14. An engine mount assembly, the assembly comprising:
a center pin;
a first and a second joining plate;
a main rubber element, formed about at least a portion of the center pin and the first and the second joining plate; and
a housing configured to receive at least a portion of the main rubber element, the center pin, and the first and the second joining plate.

15. The engine mount assembly of claim 14, wherein the first and the second joining plate include at least one tab configured to engage the housing.

16. The engine mount assembly of claim 14, wherein the main rubber element is formed about at least a portion of the center pin and the first and the second joining plate such that the main rubber element is disposed between the center pin and the first and the second joining plate.

17. The engine mount assembly of claim 14, wherein at least a portion of the first joining plate and the second joining plate is encapsulated by the main rubber element and engages at least a portion of the housing.

18. A method for producing an engine mount assembly, the method comprising:
placing at least one joining plate and a center pin at least partially into a mold;
injecting the mold with a material that at least partially encapsulates the at least one joining plate and the center pin, forming a main rubber element;
removing the main rubber element from the mold, the main rubber element including the at least one joining plate and the center pin; and
inserting the main rubber element into a housing, wherein at least one of the main rubber element, the at least one joining plate, and the center pin engage the housing.

19. The method of claim 18, wherein the at least one joining plate and the center pin are separated from each other, allowing the material to flow between the at least one joining plate and the center pin.

20. The method of claim 18, further comprising coating at least a portion of the at least one joining plate, the center pin, and the housing with at least one of:
a) a phosphate coating;
b) a primer; and
c) an adhesive.
